(19) United States
(12) Patent Application Publication
(10) Pub. No.: US 2004/0111531 A1
(43) Pub. Date: Jun. 10, 2004

(54) Method and system for reducing the rate of infection of a communications network by a software worm

(76) Inventors: Stuart Staniford, Eureka, CA (US); Clifford Kahn, Boston, MA (US); Nicholas C. Weaver, Berkeley, CA (US); Christopher Jason Coit, Davis, CA (US); Roel Jonkman, Eureka, CA (US)

Correspondence Address: PATRICK REILLY, BOX 7218, SANTA CRUZ, CA, 95061-7218, US

(21) Appl. No.: 10/313,623

(22) Filed: Dec. 6, 2002

(51) Int. Cl. G06F 15/16

(52) U.S. Cl. 709/246

(57) ABSTRACT

The methods and systems described herein provide for the detection of a software worm in a computer network, such as the Internet, and/or a limitation of the rate of infection of a software worm within a computer network. In a preferred embodiment, a worm detector software module observes the behavior of, and optionally inspects the electronic messages sent from, a particular computer system, network address, virtual machine, and/or cluster. A worm screen software program edits the flow of traffic from the network address when a possibility of a worm infection achieves a certain level. This editing may include the discarding or rerouting for storage or analysis of messages prepared for transmission by a particular computer system, network address, virtual machine, and/or cluster monitored by the worm screen. The worm screen may be co-located with the worm detector, or comprised within a same software program.

### FIELD

The present invention relates to protecting communications networks and information technology systems from infections by software worms and more particularly to a method of detecting a probability of a worm infection and methods and systems that inhibit the rate of infection of a software worm.

### BACKGROUND

Conventional computer networks, distributed information technology systems, and electronic communications systems generally include a plurality of digital computing systems, each or most systems having one or more network addresses, and/or a cell of multiple computers that share a same external address, but have different internal addresses that are relevant within the cell. Computer software viruses are software programs that effect the operation or state of a digital computer system, and are usually designed or structured to spread via transmission from one system to another. Viruses are software programs that are capable of replicating. A virus might, for example, infect other executable programs located in an infected system when an executable program is launched from the infected program.

Software worms are programs that attempt to replicate through a communications network and affect digital computing systems. Once on a system, a worm might immediately execute, or the worm might delay for a time period or pending a trigger event. An infectious worm will eventually or immediately seek out connections by which the worm can spread via transmission to other host systems. For example, suppose that a “Worm X” replicates within a computer network, such as the Internet, via electronic messaging. Alternatively or additionally, the network may optionally support FTP and/or webserver based communications When one user affected by this worm sends an electronic message, Worm X will attach itself to that electronic message, thereby spreading Worm X to the message receiving systems.

There are several types of worms, classifiable by various properties, such as target selection strategy (e.g., scanning, topological, etc.) or activating trigger (e.g., a user/host action, a timed release, an automatic behavior). A network worm will search within a computer network for systems that they might infect. Some worms spread by attacking the computers within a local network, or a cluster, or an intranet, or by randomly searching computers connected to an extranet or the Internet.

The increasing virulence of software worms, and the accelerating rate at which the new worms can spread, makes it often difficult or risky to rely upon human intervention to detect and appropriately react to a worm infection within a network or a distributed information technology system. In addition, the dangers of reacting too slowly to an infection, or reacting to a false positive, or reacting in a extreme and costly manner to a possible detection of a worm, combine to create an urgent need to provide automated or semi-automated tools that can detect a possibility of a worm infection and/or react rapidly and in reasonable proportionality to (2) the probability of an actual worm infestation, and (2) the potential virulence of a potential worm infection.

It is thus an object of the present invention to provide an automated or semi-automated procedure or software tool capable of detecting and/or suppressing a software worm infection within a distributed information technology system.

It is an optional object of the present invention to provide an automated or semi-automated procedure or software tool capable of screening communications from and/or to a network address to slow the spread of a worm infection within a computer network.

It is further optional object of this invention to provide technique for limiting the rate of infection of a worm by discarding selected messages transmitted from a particular network address, where the particular network address has been indicated to possibly be infected with a software worm.

It is another optional object of this invention to detect a probability of the presence of a software worm within a digital electronics communications network.

Consequently, there is need for an improved method and system for detecting a probability of a software worm infection within a computer network, and/or effectively moderating the operation or behavior of a computer network, or systems comprised within or linked to a computer network, to reduce or halt the rate of infection within the computer network by a software worm.

### SUMMARY

Towards satisfying these objects, and other objects that will be made clear in light of this disclosure, the present invention advantageously provides a method and system capable of detecting the presence or transmission of a software worm, and/or useful to reduce the rate of infection of a software worm in a distributed electronic information system, such as the Internet, or another suitable electronic communications network.

In a first preferred embodiment of the present invention a first software module, or worm screen, is hosted on a first computer system of a computer network. The first computer system, or first system, is identified by a network address in communications with the computer network. The worm screen resides on the first system and monitors messages received by the first system and transmitted through the computer network. The worm screen discards messages from the first system that do not meet, or conform to, one or more preset criteria, and/or disrupts a relevant communications channel to or from the first system. Optionally and alternatively or additionally, the method present invention allows for annotation to a message sent to or from the first system, whereby the annotated message may be processed in light of information or indicators provided by the annotation. The term “discard” is defined herein to comprise the action of prohibiting the transmission of an electronic message from a sending computer system and to addressees, or intended recipients of messages, of a relevant computer network. Discarded messages may, in certain alternate preferred embodiments of the present invention, be specially tagged or handled as infected, or as possibly infected messages, and transmitted to a location for storage and/or analysis.

The preset criteria may be maintained as a list, or “whitelist”, of characteristics that are used to determine if the worm screen will allow a message prepared for a transmission by a sending system, to be transmitted via the computer network, or network. The whitelist may have multiple sets of criteria, such as a list of priority of addressees to whom messages may be sent, or an indicator of the content type of the message, where a message bearing a selected content type will be sent, regardless of the addressees of the message. Alternatively or additionally, the whitelist may optionally take a form similar to certain prior art firewall rules, where either an address or a port number can be a wildcard, and where Internet Protocol addresses may have prior art notation, e.g., 13.187.12.0/24, with 24 being the number of significant bits.

In the first preferred embodiment of the present invention, and certain alternate preferred embodiments of the present invention, the whitelist may be employed in coordination with stages of worm alert severity, wherein the worm screen uses differing sets of criteria in relationship to information provided by the network concerning, for example, the likelihood that a suspected worm infection is an actual worm infection, or an urgency state of the network related to factors outside of worm infection alerts, such as an emergency weather condition, or a temporary reduction in the need for rapid communications. The pattern or specific locations of detected worm infestations, where the infestation detections may be actual, probable, or possible, may also trigger the selection of a set of operative criteria by the worm screen, wherein indications of worm infections in more sensitive network locations, or at more critical times, may lead to the application of a more stringent set of criteria from the whitelist and by the worm screen. A whitelist, or the method or employing a whitelist may optionally be updated or modified by the worm screen or by direction to the worm screen by information received from the network, a computer system, an information technology system, or an electronic communications system. Alternatively or additionally, the whitelist may be created or modified by a user or another suitable person or technologist. The whitelist may optionally be implemented as a decision procedure or algorithm, whereby authority to transmit the examined message through the network is derived from the automated computational application of the whitelist. Alternately or additionally, the worm screen might alter a message as generated by the first system, and then send on the altered message to the originally intended recipient(s) of the message. The alteration of the message may function to notify a receiving party of a special status of the message, or to disrupt the transmission of the worm by changing or rearranging the elements or content of the original message.

In certain alternate preferred embodiments of the present invention two or more network addresses may be assigned to the first system. In addition, the first system may optionally implement two or more virtual machines, and one or more virtual machine may have one or more network addresses. In certain still alternate preferred embodiments of the present invention, one or more clusters of network addresses may be defined and identifiable to the worm screen, whereby the operation of the worm screen and/or the content of the whitelist may be affected or moderated in response to the behavior of one or more virtual machines, networked computer systems, network addressees, and/or identified clusters.

In a second preferred embodiment of the present invention, the worm screen resides on a second system and monitors and screens messages presented by the first system. The second system may optionally be in communication with the network and/or may direct the communications of the first system with the network by messaging to and from the first system.

In a third preferred embodiment of the present invention, a monitoring software module, or worm detector, resides on either the first system, the second system, or another system, and monitors messages transmitted, or prepared for transmission, by the first system. The worm detector observes the behavior of the first system and notes the occurrence of events, such as anomalous behavior related to communications by the first system, that may indicate behavior indicative of a worm infection. Certain types of worms generate a flood of messages from an infected system to numerous network addresses that may or might not actually exist or be available on a network. As one exemplary behavior that the worm detector may count as indicative of a worm infection, the worm detector may note a rapid and significant increase in the message traffic from the first system, and to a plurality or multiplicity of network addresses to which the first system seldom, never, or only occasionally communicates. When an anomaly or anomalous event is noted by the worm detector, the worm detector will proceed to recalculate the incidence of anomalous events and optionally report the new incidence to one or more systems of the network. Additionally or alternatively, the worm detector may compare the contents and/or method of use of a list of message characteristics contained within or indicated by a check class definition, or CCD. The check class definition may be informed, modified, edited and updated in response to messages or directives received via the network, or in response to information received via suitable alternate media known in the art, or in response to various suitable parameters known in the art. The method of application of the check class definition may optionally be updated, structured, altered or modified in response to messages or directives received via the network, or in response to information received via suitable alternate media known in the art, or in response to various suitable parameters known in the art, such as normal message profiles.

In certain alternate preferred embodiments of the method of the present invention, the incidence of detection of indicators of possible worm infection may be related to the time of detection and the rate of detection of other indicators of possible worm infection. In certain still alternate preferred embodiments of the method of the present invention, the incidence of worm infection indicators may be calculated with an algorithm or according to a formula, such as a comparison of moving averages on a selected timescale, or another suitable statistical or predictive method known in the art. Certain still alternate preferred embodiments of the method of the present invention may optionally vary or modify the method of determining the incidence of indicators of possible worm infection, whereby the history, timing or content of a message, or information provided through the network, may cause the worm detector to change the degree of significance to place upon a specific, or each specific, observation by the worm detector of an indication of possible worm infection. As one example, the detection of messages sent from a network address that is suspected of being infected by a worm may be given higher relevance in the calculation of incidence than a receipt of a message issued by a network address that is not particularly suspected of being worm infected.

In certain alternate preferred embodiments of the method of the present invention, the worm screen and the worm detector may reside in a same system or may be comprised within a same software module, or worm alert module.

In certain still alternate preferred embodiments of the method of the present invention, to include appropriate implementations in a network wherein electronic message traffic is at least occasionally symmetrically routed, the calculation of the incidence of worm detection may include the detection of lack of responsiveness to communications attempts by the first system, or the return of ICMP port unreachable responses to the first system, or other negative responses (e.g., Reset messages, ICMP port unreachable messages, host unreachable messages, etc.) to message traffic issued by the first system. As an illustrative example, consider that in certain TCP/IP compliant networks an attempt to connect to a TCP port may result in the issuance of a RESET response message by the queried host and to the originating host of the TCP port connection attempt. Furthermore, networks operating in compliance with certain communications protocols compatible with deterministic finite automation communications, excessive reset messages or ICMP port unreachable notices may indicate worm generated messaging from the requesting host or system. The monitoring and record building of the inbound and outbound message history of a particular network address in useful in certain still alternate preferred embodiments of the present invention, wherein a correlation of suspicious messaging traffic with other suspicious message traffic, or with otherwise innocuous appearing message traffic, is derived in order to improve the detection of worm infection in systems and messages. The correlation of messages by host or system originator with a list of hosts that are a prior determined to be vulnerable to worm infection may also be optionally applied to improve detection reliability of worm infection in certain yet alternate preferred embodiments of the present invention. The method of the present invention, in certain alternate preferred embodiments, enables the detection of excessive message traffic of any recognizable type, wherein the message traffic comprises anomalous volumes of traffic of an identifiable message type or types, to be an indication of a probability of a worm infection. Detected events of a system itself, e.g., host-based IDS, may additionally or alternatively correlated with suspicious message traffic to the increase the reliability of detection of worm infection in the network and the system. Certain alternate preferred embodiments of the method of the present invention are enabled to detect probabilities of worm infection and/or suppress worm infection within distributed information technology network that comprise computing systems that employ non-deterministic processing techniques, such as probabilistic processes, and/or other suitable algorithms known in the art.

The method of the present invention may be optionally designed and applied to increase the level and intensity of worm screening when an initial level or earlier levels of worm screening failed to reduce the progress of worm infection below a certain level.

In another optional aspect of certain still alternate preferred embodiments of the present invention, a worm infection be ed within the network by marking one or more networked hosts or systems as infected, and observing the spread of an innocuous software program through out the network. The worm detectors, or monitoring systems, may track the tamed, infectious spread of the algorithm and support the calculation of the worm resistance qualities of the communications network. This simulation may enable a human system administrator an opportunity to determine the reliability of a distributed plurality of worm detectors to detect a worm infection, and the sensitivity to worm detection of the distributed plurality of worm detectors. The effectiveness of a plurality of worm screens may also been tested in a similar infection simulation.

The foregoing and other objects, features and advantages will be apparent from the following description of the preferred embodiment of the invention as illustrated in the accompanying drawings.

### BRIEF DESCRIPTION OF THE DRAWINGS

The foregoing and other features, aspects, and advantages will become more apparent from the following detailed description when read in conjunction with the following drawings, wherein:

FIG. 1 is a diagram illustrating a computer network comprising systems having network addresses;

FIG. 2 is an example of a electronic message abstract of an electronic message that might be transmitted as an electronic message, or within an electronic message, within the network of FIG. 1;

FIG. 3 is a diagram illustrating a first preferred embodiment of the method of the present invention wherein a worm screen of FIG. 1 is implemented;

FIG. 4 is a diagram illustrating a second preferred embodiment of the method of the present invention wherein the worm detector of FIG. 1 is implemented; and

FIG. 5 is a diagram illustrating a third preferred embodiment of the method of the present invention comprising an alternate preferred embodiment of the worm detector of FIG. 1.

FIG. 6 is a diagram illustrating a fourth preferred embodiment of the method of the present invention comprising an alternate preferred embodiment of the worm detector of FIG. 1, wherein the worm detector is operating within an optional portion of the network wherein electronic messages are occasionally or usually symmetrically routed.

FIG. 7 is a diagram illustrating a fifth preferred embodiment of the present invention wherein the worm detector and the worm screen of FIG. 1 are comprised within a same software program, or a worm alert module.

### DETAILED DESCRIPTION

In describing the preferred embodiments, certain terminology will be utilized for the sake of clarity. Such terminology is intended to encompass the recited embodiment, as well as all technical equivalents, which operate in a similar manner for a similar purpose to achieve a similar result. As will be described below, the present invention provides a method and a system for (1) detecting the possible or actual spread of a software worm infection within a computer network, and/or (2) limiting or halting the spread of a software worm within the network. Reference will now be made to the drawings wherein like numerals refer to like parts throughout.

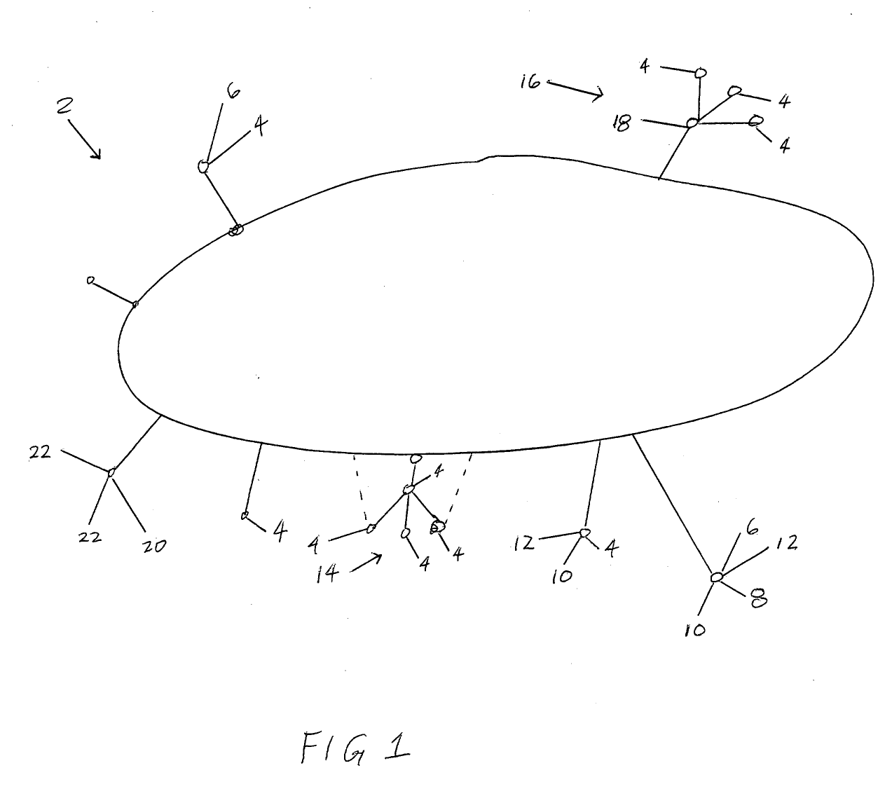

Referring now generally to the Figures and particularly to FIG. 1, FIG. 1 is a diagram illustrating a computer network 2 comprising a plurality of computer systems 4, or endpoints 4, having network addresses 6. The network 2 may be or comprise, in various preferred embodiments of the present invention, the Internet, an extranet, and intranet, or another suitable distributed information technology system or communications network, in part or in entirety. A first system 8 is coupled with the network 2 and may send and receive digital electronic messages, such as IP packets, or other suitable electronic messages known in the art. A worm detector software program 10, or worm detector 10, or monitoring system 10, may optionally reside on the first system 8, or another system 4, or be distributed between or among two, three or more computer systems 4. A worm screen software program 12 may be co-located with the worm detector 10, or may be comprised within a same software program, or may be optionally partly optionally reside on the first system 8, or another system 4, or be distributed between or among two, three or more computer systems 4. A first cluster 14 of systems 4 is coupled with the network 2, as is a second cluster 16 of systems 4. It is understood that all or at least two the systems 4 of the first cluster 14 may communicate directly with the network 2, whereas the systems 4 of the second cluster 16 must pass all communications with the network 2 via the computer system 18. In addition, FIG. 1 includes a VM computer system 20 having, or presenting and coupling to the network 2, at least one virtual machine 22, where each virtual machine 22 may have at least one network address 6. In certain alternate preferred embodiments of the present invention the VM computer system 20 may have or enable a plurality of virtual machines 22.

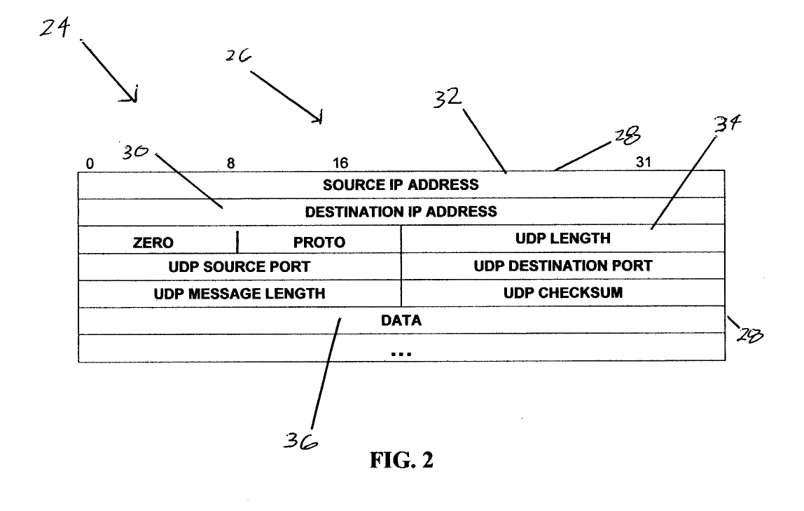

Referring now generally to the Figures and particularly to FIG. 2, FIG. 2 is an example of an electronic message abstract 24 of an electronic message 26 that might be transmitted as an electronic message, or within an electronic message, and within the network 2 of FIG. 1. The electronic message 26 might contain information in data fields 28, such as a TO address in a TO ADDRESS FIELD 30, a FROM address (i.e., the network address of the sending system 4) in a FROM ADDRESS FIELD 32, message header information in a HEADER FIELD 34, message content information in a CONTENT FIELD 36, and other suitable types of information known in the art in additional data fields 28. The message 26 may optionally contain, in suitable message types known in the art, a metaserver query, a destination system identifier, a destination virtual machine address, a destination system type, a destination port and system type, a destination cluster identifier, a source system identifier, a source virtual machine address, a source system port and source system type, a source system cluster identifier, and/or a message address pair. It is understood that a metaserver is a server that guides communication to a server or system.

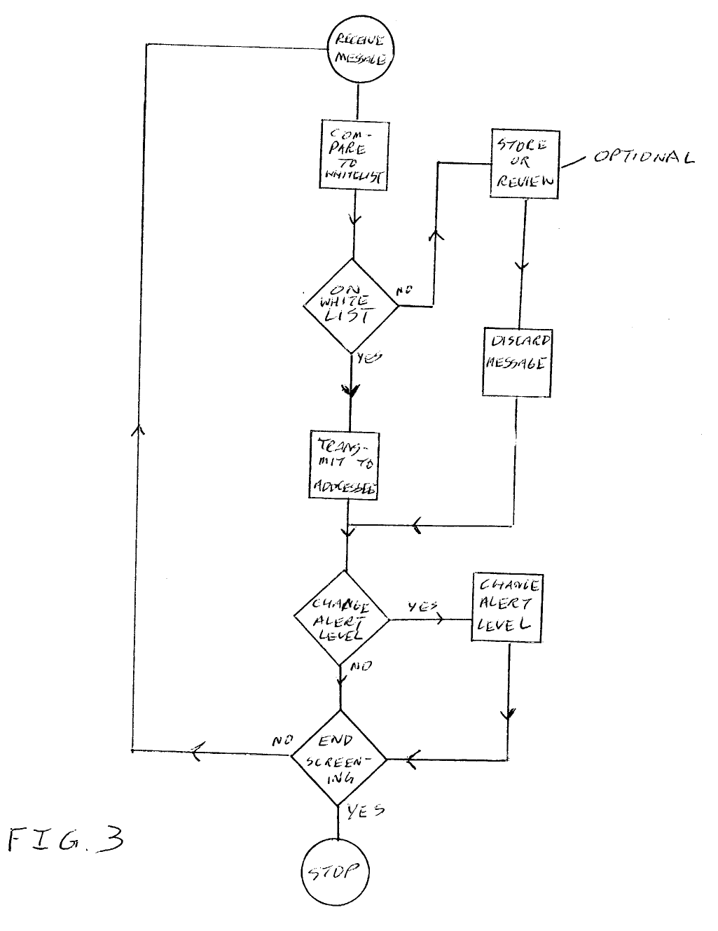

Referring now generally to the Figures and particularly to FIG. 3, FIG. 3 is a diagram illustrating a first preferred embodiment of the method of the present invention, wherein the worm screen 12 examines messages issued by the first system 8 and discards the messages that do not meet an appropriate and applicable whitelist criterion. As one example, the whitelist might contain a list of addresses that the first system may always send messages to. In addition, the whitelist might further contain a secondary list of network address to which the first system may send messages when network indicators suggest that a reduced alert level should be applied. Yet additionally, the whitelist might contain a list of addresses to which certain types of messages might always be sent, or sent on condition of a parameter of the network, a cluster, or another suitable parameter known in the art. In process flow, in the preferred embodiment of the method of the present invention of FIG. 3, where a message fails to meet a necessary and sufficient prerequisite for transmission as established by the worm screen12 in light of the whitelist and/or optionally other information and criteria, the message is discarded and not transmitted to addressees not permitted by the worm screen. In certain cases a message will be sent to certain addressees and not to other addressees. The worm screen 12 may optionally send or transmit the discarded message to an alternate network address for analysis and/or storage. Where the worm screen 12 determines that a message should be transmitted, the worm screen will transmit, or direct that the message be transmitted, to one or more authorized addressees of the message. The worm screen 12 may then optionally determine if the whitelist criteria, and other suitable criteria known in the art, should be updated or raised in alert status. The worm screen 12 will thereupon, unless it determines to or directed to cease screening messages for discard, move on to receiving the next message from the first step. This receipt of the message by the worm screen may, in certain alternate preferred embodiments of the present invention, be characterized as a message interception, as the worm screener first determines if and to whom a message will be sent before the message is transmitted beyond the system 4 or systems 4 that are hosting the worm screen 12.

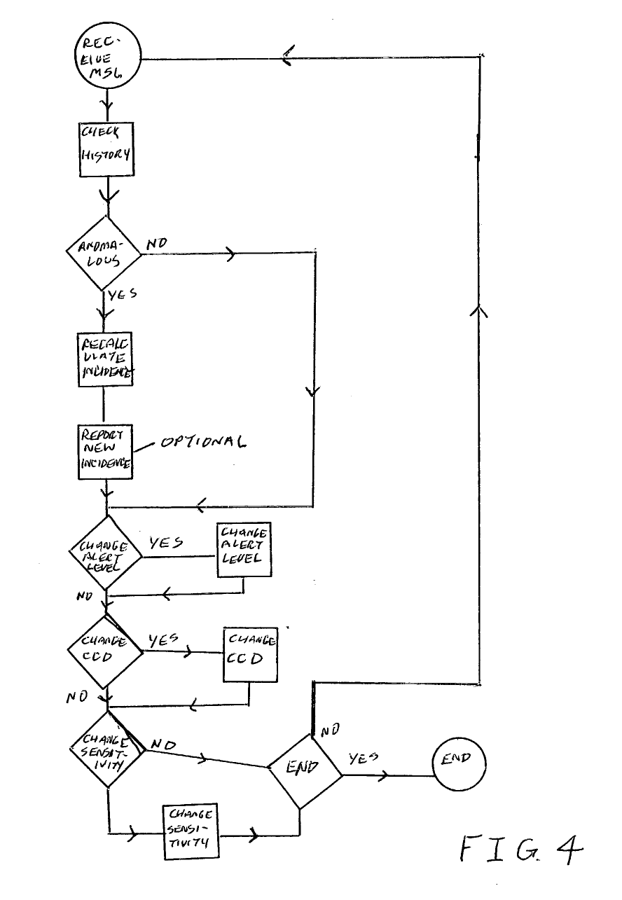

Referring now generally to the Figures and particularly to FIG. 4, FIG. 4 is a diagram illustrating a second preferred embodiment of the method of the present invention wherein a preferred embodiment of the worm detector 10, or sensor 10, of FIG. 1 is implemented. The worm detector 10 receives the message 26 as generated by the first system 8. The worm detector then checks a memory and/or a history file to determine if the addressee or addressees of the message 26 have been addressed within a certain time period, or an indication of the frequency with which the addressee or addressees have been addressed in messages sent from the first system. If one or more addressees specified in the message 26 are so rarely addressed by the first system as to make the transmission of the message to 26 to said addressee(s) to be an anomaly, then the worm detector will register the occurrence of an anomalous event. In addition or alternative, the worm detector may check one or more characteristics of the message 26 against a check class definition, or CCD, wherein a finding of the existence of certain message characteristics, and/or the absence of certain other message characteristics, and as listed within the check class definition, may result in a determination by the worm detector that the generation of the message 26 by the first system 8 comprises an anomalous event. When an anomaly or anomalous event is noted by the worm detector, the worm detector 10 will proceed to recalculate the incidence of anomalous events and optionally report the new incidence to one or more systems 4 of the network 2. The worm detector 10 may examine the contents and/or method of use of the check class definition in response to messages or directives received via the network 2, or in response to information received via suitable alternate media known in the art, or in response to various suitable parameters known in the art. The worm detector 10 may additionally or alternately change an operating level of sensitivity to anomalies, or change the formulation or content of a check class definition.

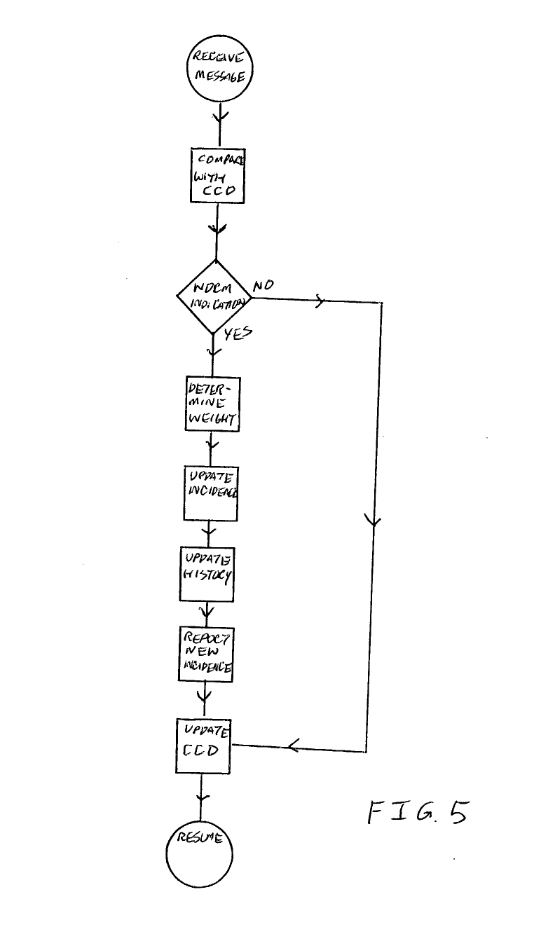

Referring now generally to the Figures and particularly to FIG. 5, FIG. 5 is a diagram illustrating a third preferred embodiment of the method of the present invention comprising an alternate preferred embodiment of the worm detector 10 of FIG. 1. In the embodiment of FIG. 5 of the worm detector 10, the message 26 is received from the first system 8 and the message is compared against the check class definition. If an anomalous characteristic, or a characteristic indicative of a possible worm infection is discovered by the check class definition comparison, the worm detector 10 will then determine the weight to give the detected anomaly, and then recalculate or update the anomaly incidence measurement related to the first system 8, or other appropriate virtual machine, network address, cluster or suitable device, network or identity known in the art. The worm detector may also optionally update the history of the monitored traffic, and/or report the newly calculated incidence value via the network to other worm detectors 10. Additionally or alternatively, the worm detector may optionally update the check class definition in response to new information or changing parameters of the first system 8, systems 4, 8or other suitable elements or aspects of the network 2 known in the art. If no anomaly is discovered by the check class definition comparison then the worm detector may optionally update the check class definition on the basis of not discovering an indication of possible worm infection. Regardless of the results of the check class comparison, the worm detector may resume checking additional messages 26 after performing the check class definition and processing the results of the check class definition. In certain preferred embodiments of the method of present invention the processing and examination of the electronic messages for the purposes of detecting (1) a worm infection, (2) a probability of worm infection, and/or (3) an indication of a worm infection, and/or for the purpose of worm infection suppression, may be performed at least in part with, or in combination with, parallel computational techniques rather than solely by sequential computational processing.

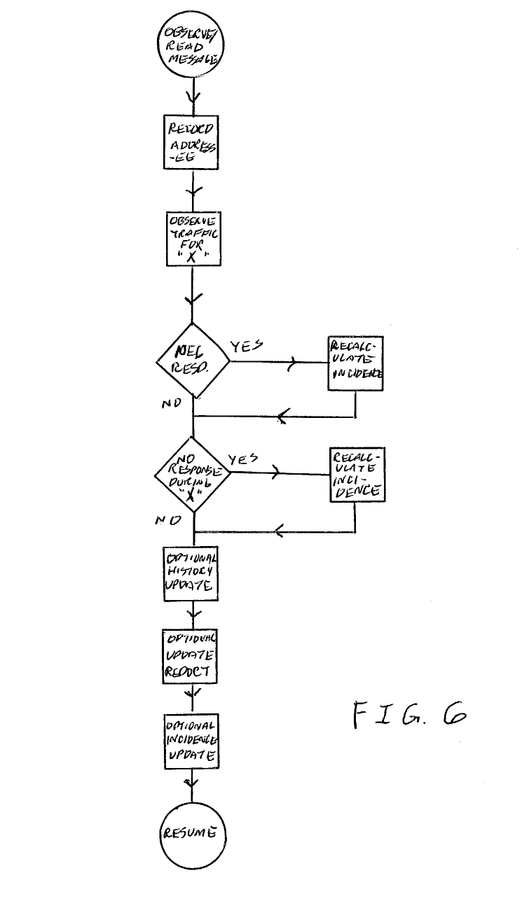

Referring now generally to the Figures and particularly to FIG. 6, FIG. 6 is a diagram illustrating a fourth preferred embodiment of the method of the present invention comprising an alternate preferred embodiment of the worm detector of FIG. 1, wherein the worm detector is operating within an optional portion of the network 2 wherein electronic messages are occasionally or usually symmetrically routed. In the fourth preferred embodiment of the method of the present invention the worm detector may optionally rely upon, when applicable, a potentially symmetric communications process of the network 2, whereby a return message is generally or often sent by a receiving network address. A lack of outgoing messages answered by response messages from addressees of the original message, or an excessive number of negative responses to message transmissions, is indicative of the activities of certain types of software worms. Additionally, the return of negative responses to communication requests by a given network address is also indicative of the modus operandi of certain types of worms. The fourth embodiment of the method of the present invention exploits this characteristic of certain types of symmetric communications traffic networks, and counts the failure of return messages and the detection of negative responses to communications request as potentially indicative of worm infection of the originating network address. The fourth embodiment of the method of the present invention monitors the outbound messages from a system or a cluster and waits for a response within a finite time period, as well as for negative responses. The incidence of anomalous events is thereby recalculated on the basis of a detected deviation from an expected response activity of uninfected electronic communications. In certain alternate preferred embodiments of the method of the present invention, the method of the fourth embodiment may be employed wherein detection of responses to messages are monitored by a plurality of worm detectors, and the worm detectors provide information to each other with the purpose of associating an original message sent from an originating network address with a specific reply to that original message, whereby lack of responses and high volumes of negative responses can be monitored within an asymmetric communications network, e.g., a load balanced network.

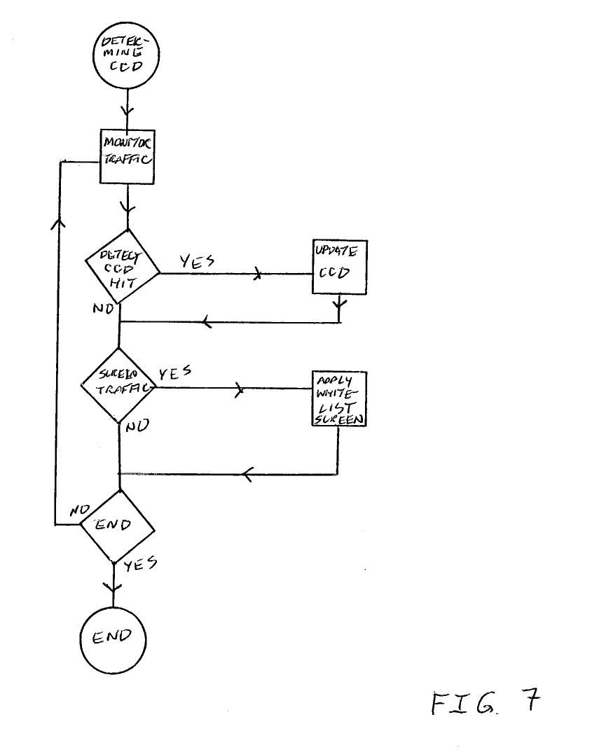

Referring now generally to the Figures and particularly to FIG. 7, FIG. 7 is a diagram illustrating a fifth preferred embodiment of the present invention wherein the worm detector 10 and the worm screen 12 of FIG. 1 are comprised within a same software program 38, or a worm alert module 38.

The worm detector 10, the worm screen 12 and the worm alert module 38 may be written in the C SOFTWARE PROGRAMMING LANGUAGE, the C++ SOFTWARE PROGRAMMING LANGUAGE, or another suitable programming language known in the art. The systems 4 may be network enabled digital electronic computational or communications systems, such as a suitable SUN WORKSTATION or another suitable electronic system known in the art.

In certain alternate preferred embodiments of whitelist and check class definitions profiles of individual systems, network addresses, virtual machines and clusters are optionally maintained and accessed within the processes of detecting and/or screening messages for worm infection. These profiles might identify the hardware and operating system associated with a particular network address, and the software programs active, running or present on a system related to a particular network address. As one example, it may be determined that systems with a WIDOWS 98 operating system and running a known version of OUTLOOK messaging software is especially vulnerable to a particular and active worm. In this example the network addresses of originators of messages may be referenced in light of the check class definition to determine if either the sender or recipient of the message are especially vulnerable to a worm infection.

An endpoint is defined herein as an address that a message can come from or go to. For example, the combination of a transport (IP), an IP address, a subtransport (e.g., TCP, UDP, and ICMP), and a port number may specify an endpoint. Endpoints may be assigned to anything that can send or receive messages, including systems 4, hosts, clusters of hosts, routers, bridges, firewalls, medical instruments, electronic devices, virtual machines, software processes, Internet appliances, and other suitable systems or processes known in the art.

An endpoint set is defined herein as a set of endpoints defined by a criterion or by enumeration. For example, an endpoint set may comprise one, more than one, or all of the endpoints monitored by one or more worm screens, or endpoints in a specific cluster, or endpoints of a particular local area network (“LAN”), or endpoints fenced in by a particular firewall, or endpoints having a particular port number or identified as running or having a particular software program or coupled with a particular type of computational hardware.

A cell is defined herein as a set of endpoints fenced in and/or monitored by one or a plurality of worm screens and/or worm detectors.

A suspicion score is a measure or indicator of how likely a message is to be infected by a worm, or to contribute to an attempt to spread a worm infection. Suspicion scores may alternatively be or comprise a Boolean value, a numeric value, and/or a moving average. In certain alternate preferred embodiments of the method of the present invention a suspicion score may be or comprise a complex object, such as a suitable probability value as defined in qualitative probability theory as known in the art.. Such complex object suspicion scores may include evidence of a possibility of an infection, wherein said evidence is useful to avoid double counting when combining pluralities of evidences and/or suspicion scores.

A danger score is defined herein as a measure of how likely a system, a software process, message, endpoint, or endpoint set is to be infected.

A suspicious message is a message that matches an attack signature or is anomalous. This anomalous characteristic of the suspicious message may be discernible in relation to an endpoint or endpoint set that the message purports to come from and any endpoint or endpoint set that the to which the message's apparent recipient belongs. Either endpoint set can optionally be a universe set that includes all endpoints within a specified network or portion of a network. Certain alternate preferred embodiments of the method of the present invention include choosing the endpoint sets to monitor. Three possible choices are (1) to monitor the source and recipient host address, (2) to monitor the source cell and recipient host address, (3) to monitor the source, the recipient host address, the source cell and the recipient host address. These tests may yield a suspicion score.

A suspicious exchange is defined herein as a sequence of messages between a first endpoint or endpoint set and a second endpoint or endpoint set that matches an attack signature, or a stateful inspection, or is anomalous or some combination of both. For example, if a host sends a TCP SYN message to a second host and the second host does not respond, or responds with a TCP RESET or an ICMP Port Unreachable or similar message, that would match an attack signature. More generally, a suspicious exchange might be defined in terms of a Deterministic Finite Automation criterion or a logical algorithm. These tests may yield a suspicion score. It is understood that a suspicious message is a degenerate case of a suspicious exchange.

A scanning worm is worm that locates new targets by scanning—by trying out endpoints to see what responses it gets. The behavior of certain scanning worms may be similar to, or comprise, war dialing, a process well known in the art.

The sixth preferred embodiment of the method of present invention may be implemented in a communications network having real-time or near real-time constraints, and may comprise the follows steps and aspects:

1. Observing for suspicious messages and/or exchanges that suggest worm activity.

a. Observations may be focussed or include potential victims and/or on other hosts connected to the network, including specialized worm monitoring devices or systems 4.

b. More than one piece of equipment, system 4 or software agent can cooperate in watching an exchange; this aspect is valuable if traffic is divided over two or more routes, either because routing is asymmetric, or because of load balancing, or for any reason, and may also be useful for dividing load among the watchers, e.g., systems 4.

c. Examples of suspicious messages and exchanges include:

i. A message that elicits no response;

ii. A message that elicits a response indicating that the recipient endpoint does not exist (“the number you have reached is not a working . . .”); and

iii. A message to a destination endpoint that is anomalous (again, this may be anomalous; in relation to any endpoint set that the message purports to come from and any endpoint set that includes that recipient endpoint; examples would be a destination IP address anomalous for the source IP address, and a destination IP address anomalous for the source cell).

2. Accumulate evidence of worm presence or activity:

a. If an “x” system 4 talks to a “y” system 4 multiple times and gets multiple signature violations, it is important count only one violation, since benign sources may make repeated attempts, whereas worms gain nothing by repeated attempts.

b. The accumulation of evidence of worm presence or activity comprises maintaining suspicion scores and danger scores as per the following optional steps:

Suspicion score associated per a source endpoint or endpoint set:

For example, per source IP address;

For example, per cell, or per area fenced in by a firewall;

Danger score associated per a recipient endpoint or recipient endpoint set:

For example, per recipient port number;

Or per type of recipient software; and

Combinations of factors and other factors known in the art can be considered.

3. Suspicion by association

a. If there is a message from endpoint set A to endpoint set B, and then A comes under suspicion, some of this suspicion is attached to B, whether the suspicion comes before or after the A-to-B message. If B comes under suspicion after the message, some suspicion is attached to A.

b. For example, for every message over the last five minutes or so, one might store in memory the source and recipient endpoints and perhaps other information extracted from the message. Then when raising the suspicion score of an endpoint set A the sixth preferred embodiment of the present invention may optionally proceed in this fashion:

i. For one or more selected endpoint sets B that A has recently sent a message to, increase the suspicion score of B;

ii. Especially if the recipient endpoint was also in an endpoint set C that has an elevated danger score, e.g., a port number that is under attack;

iii. For one or more selected endpoint sets D that have recently sent a message to A, increase the suspicion score of D. One benefit of this optional aspect of the sixth preferred embodiment of the method of the present invention is that one learns that a host is infected sooner and can squelch its messages sooner, so that the infected host has fewer opportunities to infect others.

c. The sixth preferred embodiment of the method of the present invention may optionally damp to prevent rumors of worm detection from sweeping through all or pluralities of the hosts or systems 4. An optional preferred way to do this is to keep chains of evidence very short. So, if A's suspicious behavior impugns B (causing B's suspicion score to be raised slightly), the present invention might well not let that behavior in turn impugn another host.

4. Track evidence of breaches of defenses

a. A breach is when a worm spreads past a worm screen, i.e., escapes from a cell;

b. The more breaches, the more infectious the worm;

c. The worm screen increases its suspicion scores as a worm is determined to be more infectious;

d. Breaches are detected when sensors 10 report attacks coming from different cells, and particularly infected messages attempt to attack the same endpoint or endpoint set;

e. The worm detectors 10, or sensors 10, that detect this may be the ones adjoining the attacking cells—they are the best position—or may be other sensors 10 elsewhere in the network; and

f. The sixth preferred embodiment of the present invention may optionally track how many breaches have occurred, e.g., track per a suitable worm signature or behavior known in the art, such as per type of target or per target port number, or combinations of suitable worm signatures or behaviors known in the art.

4. Accumulate normal profiles and dynamically maintain and edit a traffic whitelist

a. A traffic white list is a profile of traffic that has been going on;

b. For example, a set of pairs of endpoint sets that have been communicating recently, perhaps with a moving average of how much they have been communicating;

c. The pairs may be unordered or ordered; for example, the endpoint sets might be IP addresses;

d. The dynamic traffic white list might be accumulated, edited and maintained on an enforcer system 4 having a worm screen, or another system 4 or combination of systems 4.

5. Blacklist endpoints

a. The blacklisting can be done by various network devices—firewalls, routers—and by potential victims;

b. The blacklist may computed from suspicion scores and advisories;

c. The blacklist may be a particular source endpoint or endpoint set, such as an IP address or a cell;

d. The blacklist may be a particular destination endpoint set, such as a port number, particular server software, or a cell;

e. The blacklist may be a particular message signature or a message exchange signature;

f. The dynamic traffic whitelist may be enabled to override or at least be weighed against blacklist;

g. Combinations: blacklist determinations could be computed from all of the above, by combining suspicion scores for example

h. The blacklist may be used to temporarily latch an electronic message or traffic flow until a technologist examines the situation and instructs the network 2 on how to proceed.

6. The method of the present invention may be optionally designed and applied to increase the level and intensity of worm screening when an initial level or earlier levels of worm screening failed to reduce the progress of worm infection below a certain level. Enforcement of blacklists and worm screening actions can be accomplished by various network devices, e.g., firewalls, routers, and by potential victims. The plurality of worm sensors 10 may observe the incidence of indication occurring after screening and discarding of messages, and/or other suitable counter-measures known in the art, is initiated by at least one worm screen. The worm sensors 10 may compare the detected incidence of worm infection to a preestablished level, or an otherwise derived level, of worm infection increase or progress; where the progress of worm infection is detected by the worm sensors as exceeding the preestablished or derived level of progress, the sixth preferred embodiment of the method of the present invention may proceed to increase the level or stringency of the worm screening actions, and/or other suitable worm infection counter-measures known in the art, within the communications network. The present invention may thereby be optionally employed to increase the intensity and/or incidence of worm screening activity by the worm screens 8, and/or narrow the whitelist, to more stringently respond to a worm infection when the progress of the worm infection is not sufficiently impeded by worm screen activity and other counter-measures.

The method of the present invention may be implemented via distributed computational methods. As one example, a sensor 10 might accumulate evidence locally and transmit notice of the accumulated evidence when the local accumulation reaches a preset threshold. This approach may reduce message traffic load on the network 2. Alternatively or additionally, the worm screens 12 may be informed of what the worm sensors 10 have recently detected; this sharing of information may be accomplished via peer-to-peer communications among the worm screens 12 and the worm sensors 10, or via a server, or by other suitable equipment and techniques known in the art. These advisories issued by the sensors 10 and received by the screens 12 may optionally specify one or more endpoints under attack by a worm, and/or the source endpoint or endpoints emitting the attacking messages. The information provided to the worm screen 12 may be varied in relationship to the nature of the worm screen 12 and/or in light of the nature of the issuing worm sensor 10. For example, the worm screens 12 tasked with guarding an endpoint that is under attack may receive more information about the worm attack from a sensor 10 than the same sensor 10 might provide to a worm screen 12 that is not immediately tasked with protecting the attacked endpoint.

It is understood that the worm detecting and worm screening functions can, in certain applications, be performed on a single device. A system administrator or other suitable and empowered technologist might set up a process in which a single central system 4 might (1) do most or all of the accumulating of worm indications, and (2) do most or all of the blacklisting and screening of electronic messages, for an intranet, a LAN, or any suitable network 2 known in the art. A low cost antiworm solution might include a single sensor 10 and a single screen 12 where the magnitude of message traffic permits the sufficiently effective use of a single sensor 10 and a single screen 12.

Having disclosed exemplary embodiments and the best mode, modifications and variations may be made to the disclosed embodiments while remaining within the subject and spirit of the invention as defined by the following claims. Those skilled in the art will appreciate that various adaptations and modifications of the just-described preferred embodiments can be configured without departing from the scope and spirit of the invention. Other software worm detection and software worm infection rate reduction techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

We claim:

1. In a communications network having at least near real-time constraints, and the network including a plurality of network addresses, a method for reducing the rate of infection of a software worm, the method comprising:
a. monitoring at least a fraction of messages transmitted from a first network address of a first system;
b. determining by a monitoring system if each monitored message falls within a check class definition;
c. counting the incidence of messages that fall within the check class definition;
d. determining if the incidence of monitored messages falling within the check class definition exceeds a preset rate; and
e. when the preset rate is exceeded, discarding an unreceived message denoted as issued by the first network address that fails to meet a whitelist class definition.

2. The method of claim 1, wherein the method further comprises simulating a computer software worm infection, comprising:
f. establish a check class definition;
g. monitoring the communications network by a plurality of monitoring systems, each monitoring system inspecting messages at a separate monitoring location within the network;
h. setting an incidence threshold of messages falling within the check class definition that when exceeded at at least one monitoring location triggers an issuance of a worm alert by at least one monitoring system;
i. identifying a host list of vulnerable network addresses;
j. identifying a source network address as infected by a software worm;
k. run a spreading algorithm from the source network address;
l. monitoring the vulnerable network addresses for signs of a simulated infection by the spreading algorithm; and
m. continuing the running of the spreading algorithm until all network addresses identified on the host list are determined to be infected by the spreading algorithm.

3. The method of claim 2, the method further comprising ceasing the running of the spreading algorithm when until all network addresses identified on the host list are determined to be in a state selected from the group consisting of (1) infected by the spreading algorithm and (2) entered on a blacklist.

4. In a communications network having a plurality of network addresses, a method for reducing the rate of infection of a software worm, the method comprising:
a. creating a whitelist;
b. detecting a possible worm infection in the network; and
c. discarding a message sent to a first network address where the message does not conform to the whitelist.

5. In a communications network having a plurality of network addresses, a method for reducing the rate of infection of a software worm, the method comprising:
a. detecting a possible worm infection in the network;
b. taking counter measures to reduce the progress of infection;
c. determining if the progress of the worm infection is sufficiently impeded; and
d. when the progress of worm infection is insufficiently impeded, taking additional countermeasures to reduce progress of the worm infection.
